(19) United States
(12) Patent Application Publication
(10) Pub. No.: US 2021/0048259 A1
(43) Pub. Date: Feb. 18, 2021

(54) THERMAL ACTUATOR

(71) Applicant: PRATT & WHITNEY CANADA CORP., Longueuil (CA)

(72) Inventors: Ignazio BROCCOLINI, Montreal (CA); Marc-Antoine GARCEAU, La Prairie (CA); Marc-André TREMBLAY, Montréal (CA)

(21) Appl. No.: 16/537,702

(22) Filed: Aug. 12, 2019

(51) Int. Cl. F28F 13/14; F03G 7/06; F16J 1/02; F16J 9/12

(52) U.S. Cl. CPC F28F 13/14; F03G 7/06; F28F 2013/008; F16J 9/12; F16J 1/02

(57) ABSTRACT

The thermal actuator can have a housing, a moving member, a sensing portion configured to move the moving member relative the housing when receiving heat from a source of heat, and a thermal insulator between the sensing portion and the source of heat.

### TECHNICAL FIELD

The application relates generally to thermal actuators and, more particularly, to a thermal insulator for such actuators.

### BACKGROUND OF THE ART

Thermal actuators come in various forms and often generally include a mass of wax or other high-thermal-expansion material which expands and contracts in response to an increase and decrease in temperature due to thermal expansion, pushing a piston, or otherwise moving a member, as a result. This general principle is used in “rubber boot”, “diaphragm” (metal or elastomeric), and “plunger piston” thermal actuators, for instance. Thermal actuators are used in various contexts, engine thermal management systems being only one possible example. While thermal actuators were satisfactory to a certain extent, there remained room for improvement.

### SUMMARY

In one aspect, there is provided a thermal actuator comprising a housing, a moving member, a sensing portion configured to move the moving member relative the housing when receiving heat from a source of heat, and a thermal insulator between the sensing portion and the source of heat.

In another aspect, there is provided a gas turbine engine comprising a compressor, a combustor, and a turbine, with the compressor and the turbine being rotatably housed in an engine casing, a thermal actuator having a housing mounted to the engine casing, a moving member, a sensing portion exposed to a source of heat and configured to move the moving member relative the housing when receiving heat from the source of heat, and a thermal insulator between the sensing portion and the source of heat.

In a further aspect, there is provided a method of operating a thermal actuator having a piston and an thermal expansion media received in a housing, the method comprising: increasing the temperature of an environment surrounding the thermal expansion media; impeding the transfer of heat from the environment to the thermal expansion media via a thermally insulating material, and thereby delaying an increase in temperature of the thermal expansion media stemming from the increase of temperature of the environment; and the thermal expansion media expanding and pushing the piston due to the increase in temperature of the thermal expansion media.

### DESCRIPTION OF THE DRAWINGS

Reference is now made to the accompanying figures in which:

FIG. 1 is a schematic cross-sectional view of a gas turbine engine;

FIG. 2 is a cross-sectional view of an example of a thermal actuator.

### DETAILED DESCRIPTION

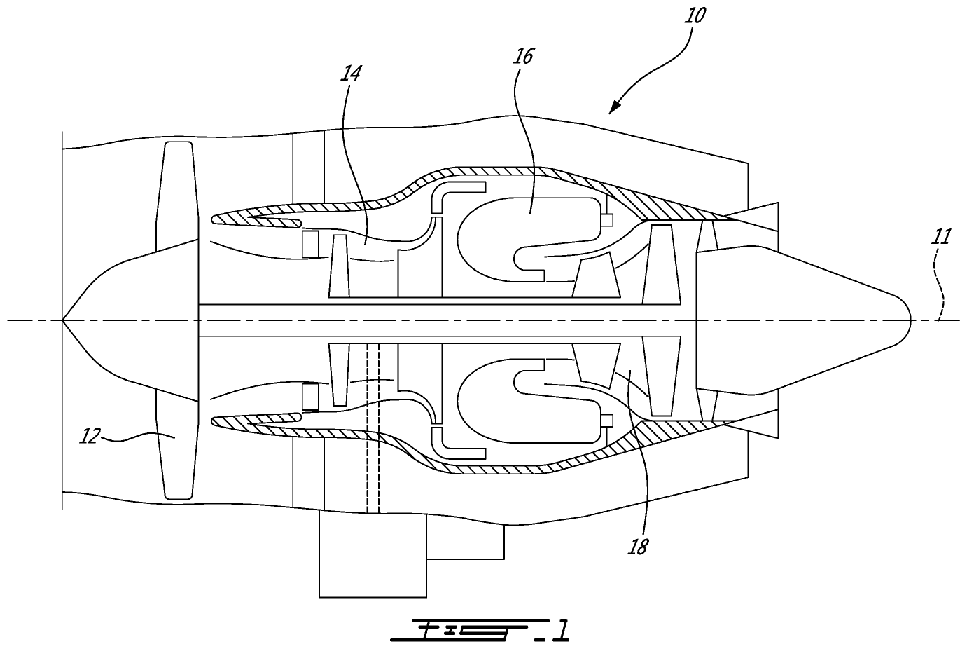

FIG. 1 illustrated a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

Gas turbine engines can use thermal actuators for various reasons, one example being the engine thermal management system, another being a thermal valve, for instance.

Generally, what is desired about a thermal actuator is for the thermal actuator to have a definite and reliable response to a change in temperature of the environment which it is configured to sense. However, in some embodiments, the temperature can vary significantly and relatively quickly. This can lead to undesired phenomena such as high cycling of the actuator, or uneven heat distribution in the (temperature) sensing portion of the actuator. High cycling may be preferably avoided in a context where the service life of actuators is often expressed in a number of cycles. Uneven heat distribution can affect the reliability of the response and/or affect service life, for instance.

It was found that at least in some embodiments, the amount of cycling could be reduced, or the temperature of the sensing portion be more evenly distributed, by providing a thermal insulator between the sensing portion and the source of heat (or source of temperature variation). This may be achieved at the cost of a delayed response, but a delayed response may be perfectly acceptable in some embodiments.

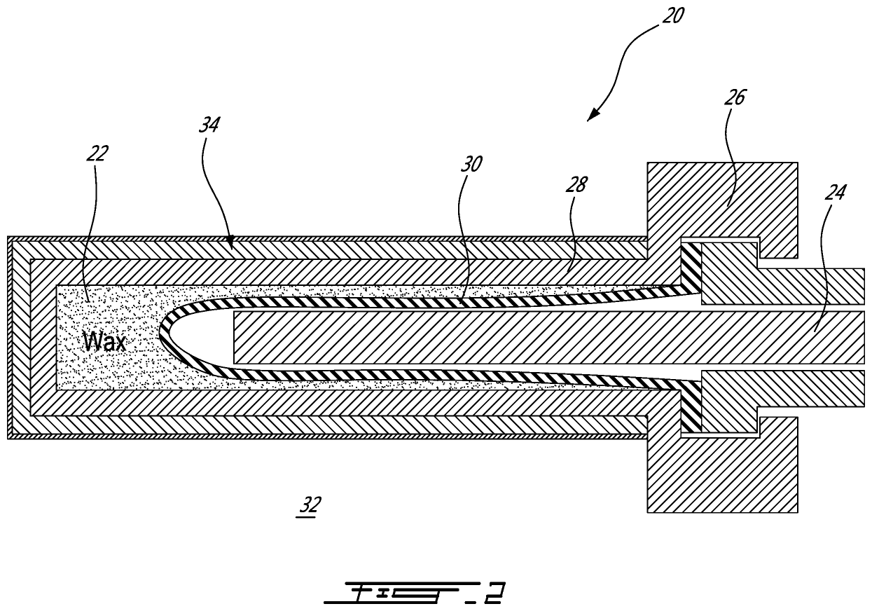

An example of a thermal actuator 20 is presented in FIG. 2. In this example, the thermal actuator 20 is a rubber boot actuator. The thermal actuator 20 generally has a sensing portion 22, which is configured in a manner to move a moving member 24 in response to an increase in temperature of the environment which it is designed to react to. The moving member 24 can be received in a housing 26. In the case of the rubber boot actuator illustrated, the housing 26 has a cup portion 28 which holds a mass of wax or another material having a high thermal expansion coefficient. The mass of wax acts as the sensing portion 22. A piston, acting as the moving member 24, is slidably mounted in the housing 26 and protrudes into the cup 28, the piston being partitioned from the wax by a rubber boot 30. The actuator 20 is configured to be mounted to a structure in a manner that the cup 28 is exposed to the temperature of the environment 32 of which the actuator 20 is configured to be responsive to. In the context of a gas turbine engine 10, the structure can be an engine casing, a liquid or gas conduit, or any suitable location, for instance. The environment 32 can be considered a source of heat in this context. The cup 28 can be made of a metal or other high thermal conductivity material in a manner to favor the exchange of heat between the source of heat and the mass of wax 22 in a manner that when the temperature increases, the mass of wax 22 thermally expands and pushes the piston outwardly via the rubber boot 30. A spring or other biasing member is typically provided to bias the piston back to the retracted state and ensuring its return once the temperature has cooled back down.

In this embodiment, the relatively high frequency of temperature variations of the environment 32 lead to high cycling or otherwise problematic actuator operation. Accordingly, a thermal insulator 34 is provided between the source of heat 32 and the sensing portion 22. The thermal insulator 34 can take the form of a layer of thermally insulating material, or the cup 28 itself can be made of a thermally insulating material instead of a metal, for instance, in another embodiment. While the illustrated actuator 20 uses a rubber boot construction as an example, it will be understood that the same principle of partitioning the sensing portion from the source of heat by a thermal insulation can be applied to other types of thermal actuators, such as diaphragm-type thermal actuators (which can be also be referred to as “bellows” type actuators, and of which the diaphragm can be metal or elastomeric, for instance), or plunger piston-type thermal actuators, or stacked seals actuators, to name a few examples.

A person having ordinary skill in the art can easily distinguish a material having thermally insulating properties from a material which has a high thermal conductivity. However, for increased clarity, and perhaps by abundance of caution, it will be stated here that a material having thermally insulating properties has a thermal conductivity of less than 0.5 W/(m*K). Indeed, most thermally insulating materials will have a thermal conductivity of less than 0.1 W/(m*K) and even less than 0.05 W/(m*K). Air has a very low thermal conductivity of 0.026 1 W/(m*K) at 25° C. and can be very good to use as a thermal insulator though this typically requires to partition the air into cells to avoid the creation of large convection movements which can impede the thermal insulation effect. Styrofoam is also an excellent thermal insulator with a thermal conductivity of 0.033 W/(m*K) at 25° C. The exact thermally insulating material can be selected as a function of the specific environment of use in the specific application, and so some environments may warrant choosing a material that has better chemical, thermal and/or structural resistance, for instance, even if this is made at a trade-off of higher thermal conductivity. Thermally insulating materials have a thermal conductivity value which can starkly contrast with the thermal conductivity of materials which are good thermal conductors, such as many metals for instance, which can have a thermal conductivity well above 100 W/(m*K).

The absolute value of the thermally insulating effect will be affected by the thickness of the thermally insulating material, and even a poorer thermal insulator can achieve a satisfactory amount of thermal insulation by being provided in sufficient thickness, in some embodiments. The insulating value of thermally insulating materials is often provided in the unit of R-value per inch of thickness in this context, the R-value being expressed in units of (ft²*° F.*h/BTU). In the context presented herein of a thermal actuator, the thermally insulating layer can have an R-value per inch of thickness of at least 0.5. which can be achieved with a ⅛^{th} of an inch thickness of moulded expanded polystyrene (EPS) high-density (R-value of 4.2 per inch), for instance, or of a thicker layer of a material having a lower thermal conductivity value. In practice, it can be preferred for the R-value per inch of thickness of the insulating layer to be above 0.5 and possibly above 1, and perhaps even higher, depending of the application.

The thickness of the thermally insulating material can be greater than 1/16^{th} of an inch, greater than ⅛^{th} of an inch, or greater than ¼ of an inch, for example, and thicker than a film.

The layer of thermally insulating material can be designed in a manner to entirely cover the sensing portion, in a manner to favor a more uniform exposure to heat, or if it is known that a certain region of the environment will be hotter than another region, a greater thickness of thermal insulation can be provided at the hotter region, for instance. In the context of an actuator where the thermally expanding sensing material is contained in a “cup” which is configured in a manner to be exposed to the source of heat, the layer of thermal insulation can be provided in the form of a sleeve entirely covering the cup, for instance.

The thermal layer dampens the effect of temperature changes of the environment/source of heat, and can therefore be considered a response time dampener for the thermal actuator 20. The thermal layer can be an additional layer of gas, fluid or solid around the thermal actuator, for instance. The thermal layer can be configured in a manner to optimize the temperature gradient in the thermal actuator. The thermal layer can also cover the actuator only partially to, for instance, influence the temperature gradient at specific places only, or to reduce envelope and weight of the design.

The thermal insulation can make the external source of heat less efficient, slow down the heating process of the heat sensing portion, and/or balance the thermal gradient across the actuator.

The above description is meant to be exemplary only, and one skilled in the art will recognize that changes may be made to the embodiments described without departing from the scope of the invention disclosed. For instance, another thermal expansion media than wax can be used in alternate embodiments. In the case of a “plunger piston” type of thermal actuator, a dynamic seal may use to prevent the wax from leaking out of the housing. Still other modifications which fall within the scope of the present invention will be apparent to those skilled in the art, in light of a review of this disclosure, and such modifications are intended to fall within the appended claims.

1. A thermal actuator comprising a housing, a moving member, a sensing portion configured by thermal expansion of a material to move the moving member relative to the housing when receiving heat from a source of heat, and a thermal insulator thermally partitioning the sensing portion from the source of heat.

2. The thermal actuator of claim 1 wherein the sensing portion is a mass of wax contained in the housing.

3. The thermal actuator of claim 2 wherein the moving member is a piston slidably received in the housing, the piston biased to a retracted position and moveable outwardly against the bias by the sensing portion.

4. The thermal actuator of claim 3 wherein the piston is partitioned from the mass of wax by a rubber boot.

5. The thermal actuator of claim 3 wherein the piston is partitioned from the mass of wax by a diaphragm.

6. The thermal actuator of claim 2 wherein the mass of wax is enclosed in a cup portion of the housing.

7. The thermal actuator of claim 6 wherein the cup is covered by the thermal insulator.

8. The thermal actuator of claim 7 wherein the cup is made of metal.

9. The thermal actuator of claim 1 wherein the thermal insulator has a thermal conductivity less than 0.5 W/(m*K).

10. The thermal actuator of claim 1 wherein the thermal insulator has an R-value per inch of thickness of at least 0.5.

11. The thermal actuator of claim 1 wherein a layer of the thermal insulator entirely covers a portion of the thermal actuator exposed to the source of heat.

12. A gas turbine engine comprising a compressor, a combustor, and a turbine, with the compressor and the turbine being rotatably housed in an engine casing, a thermal actuator having a housing mounted a non-rotary component of the engine, a moving member, a sensing portion exposed to a source of heat and configured to move the moving member relative the housing when receiving heat from the source of heat, and a thermal insulator between the sensing portion and the source of heat.

13. The gas turbine engine of claim 12 wherein the sensing portion is a mass of wax contained in the housing.

14. The thermal actuator of claim 13 wherein the moving member is a piston slidably received in the housing, the piston biased to a retracted position and moveable outwardly against the bias by the sensing portion.

15. The thermal actuator of claim 14 wherein the piston is partitioned from the mass of wax by a rubber boot.

16. The thermal actuator of claim 14 wherein the piston is partitioned from the mass of wax by a diaphragm.

17. The thermal actuator of claim 13 wherein the mass of wax is enclosed in a cup portion of the housing.

18. The thermal actuator of claim 17 wherein the cup is covered by the thermal insulator.

19. The thermal actuator of claim 18 wherein the cup is made of metal.

20. A method of operating a thermal actuator having a piston and an thermal expansion media received in a housing, the method comprising:
increasing the temperature of an environment surrounding the thermal expansion media;
impeding the transfer of heat from the environment to the thermal expansion media via a thermally insulating material, and thereby delaying an increase in temperature of the thermal expansion media stemming from the increase of temperature of the environment;
the thermal expansion media expanding and pushing the piston due to the increase in temperature of the thermal expansion media.
